(19) United States
(12) Patent Application Publication
(10) Pub. No.: US 2006/0075071 A1
(43) Pub. Date: Apr. 6, 2006

(54) Centralized management of digital files in a permissions based environment

(76) Inventor: Joseph G. Gillette, Margate, FL (US)

Correspondence Address: Steven M. Greenberg;Christopher & Weisberg, P.A., Suite 2040, 200 East Las Olas Boulevard, Fort Lauderdale, FL, 33301, US

(21) Appl. No.: 10/946,243

(22) Filed: Sep. 21, 2004

(51) Int. Cl. G06F 15/16

(52) U.S. Cl. 709/219; 709/203

(57) ABSTRACT

A centralized file management method, apparatus and article of manufacture for use in a permissions based environment. A network file transfer method can include the steps of, responsive to the activation of a browse control in a file transfer user interface, displaying a file hierarchy for locally accessible files. At least one file can be selected from the hierarchy and the displaying and selecting steps can be repeated for additional activations of the browse control. Finally, subsequent to the repeating step, each of the selected files can be uploaded to a centralized data store over a computer communications network. In a preferred aspect of the invention, the method can include compressing at least two of the selected files into a compressed file, recording a file hierarchy for the at least two selected files, aggregating the file hierarchy and the compressed file, and, uploading the aggregation to the centralized data store along with the selected files.

### FIELD OF THE INVENTION

The present invention relates to file management in a computing system and more particularly to the centralized management of digital files in a permissions based environment.

### BACKGROUND OF THE INVENTION

File management generally relates to the storage and organization of digital files in a computing system. Early network computing operating systems provided for centralized file storage and management in which centrally stored digital files could be accessed, modified and stored through remote computing terminals. More recent network computing operating systems provide for both distributed and centralized file storage and management in which stored digital files can be accessed, modified and stored through local and remote computing devices which can range from remotely connected workstations to wirelessly bound handheld computers such as personal digital assistants and cellular telephones.

Permissions based environments generally relate to computing environments where users can access computing resources based upon pre-assigned permissions. In the prototypical computing circumstance, an end user can access servers, printing resources and outbound communications facilities only if the requisite permissions have been established for the end user. Early network operating systems provided for the centralized management of permissions, usually as part of the operating system itself where user permissions could be stored in a single user permissions file. More recent network operating systems implementation provided for the management of user permissions in a centralized registry.

The advent of global computer communications networks such as the Internet have blurred what can be viewed as the network operating system, and in many cases, the need for a network operating system has all but evaporated. In the past decade, communicatively linked computers have engaged in computing interactions characteristic of a network environment, though the computers themselves had not bee explicitly linked in a single network in an exclusive manner. Rather, computing interactions between distributed computing devices over the Internet can be viewed as an ad-hoc network environment which constantly changes as computing devices enter and exit the network environment.

Given the fluid, ever-changing structure of the Internet, permissions based file management has become a daunting task, even for the most sophisticated information technologist. In particular, managing the permissions for a file can be difficult in as much as locating a suitable, centralized location to store the permissions can be difficult. Moreover, given the limited bandwidth of network communications, the large scale movement of individual files from computing client to computing client can be time consuming and resource expensive. Finally, from the end-user perspective, knowing when new files can be accessed which are permitted to be accessed can involve substantial guesswork.

Most recently, Web based interfaces have been developed in the context of centralized file management. Some document management systems deploy Web based access as a convenience tool for the occasional remote user. For example, groupware applications provide for Web based access to files which can be uploaded and downloaded at will. Rudimentary security can be applied to file through plug-in logic such as password-protected compression technology, or through encryption technology. Notwithstanding, groupware products manages file transfers through the Web interface much in the same way the groupware products manage file transfers through a native interface.

To that end, the challenges of Web based computing have not been addressed adequately by groupware products. For instance, to upload a series of files to a centralized file store using a groupware application can require the serial selection and transfer of individual files from the client to the server. To avoid a time consuming, serialized upload, separate compression software can be utilized to group a selection of files into a single, compressed file. Subsequently, the single, compressed file can be uploaded to the server. Notwithstanding, the time necessary to process the set of files using compression software prior to uploading the single compressed file can easily match that which otherwise would have been required performing a serialized upload of all of the files.

Recent, pure-play Internet file management systems similarly have not proven adequate for centralized management of digital files in a permissions based environment. In this regard, unlike conventional groupware, pure-play Internet file management systems presume Web access as a general rule. As such, much of the user interface for an Internet based system addresses the obvious short-fallings of the customary user interface for groupware applications. Nevertheless, like groupware, pure-play Internet file management systems suffer from several deficiencies which render pure-play Internet file management systems unsuitable for enterprise use.

First, pure-play Internet file management systems address the needs of the small office home office and individual user. Notions of the permissions based environment simply do not exist in the consumer driven pure-play Internet file management system marketplace. In fact, in many cases, the pure-play Internet file management system has been distributed to the consuming public at no cost as an auxiliary feature of a Web portal. Second, the time consuming process of serialized uploads remains a necessary requisite for interacting with the file management system. Finally, user awareness of newly added files remains a task reserved for the end user. In fact, despite the Web-centric focus of the pure-play Internet file management system, the user interface lacks many of the essential features required by a robust, centralized file management system. Consequently, a need remains for a robust centralized file management system able to operate in a permissions-based environment.

### SUMMARY OF THE INVENTION

The present invention advantageously provides a centralized file management system which overcomes the limitations of the prior art and provides a novel and non-obvious centralized file management method, apparatus and article of manufacture for use in a permissions based environment. In accordance with the present invention, a network file transfer method can include the steps of, responsive to the activation of a browse control in a file transfer user interface, displaying a file hierarchy for locally accessible files. At least one file can be selected from the hierarchy and the displaying and selecting steps can be repeated for additional activations of the browse control. Finally, subsequent to the repeating step, each of the selected files can be uploaded to a centralized data store over a computer communications network.

In a preferred aspect of the invention, the method can include compressing at least two of the selected files into a compressed file, recording a file hierarchy for the at least two selected files, aggregating the file hierarchy and the compressed file, and, uploading the aggregation to the centralized data store along with the selected files. Additionally, the method can include the additional step of designating different target paths for different ones the selected files. Similarly, the method can include the additional step of designating different permissions for different ones of the selected files. Finally, the method yet further can include the additional step of designating different search keywords for different ones of the selected files. In any event, the method can include the step of specifying whether the compressed file is to be automatically expanded when downloaded from the centralized data store.

In another preferred aspect of the invention, the method can include the step of rendering a user specific content alert in the file transfer user interface responsive to detecting a state change in the centralized data store. Moreover, the method can include the steps of associating the content alert with a content marker, and rendering the content market adjacent to a file associated with the state change. In this regard, a distributable file transfer user interface article of manufacture can include each of a file navigation display region, a file listing display region; and a content alert configured to alert viewers to state changes to content which can be accessed through the display regions. The article of manufacture further can include at least one content marker associated with the content alert and positioned adjacent to content associated with a state change.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a centralized file management system configured for deployment in a permissions based environment in accordance with the present invention;

FIG. 2 is a screen shot of an exemplary user interface configured for use in the centralized file management system of FIG. 1;

FIG. 3 is a screen shot of an exemplary user interface configured for adding content in the centralized file management system of FIG. 1;

FIG. 4 is a screen shot of an exemplary user interface configured for sharing content in the centralized file management system of FIG. 1;

FIG. 5 is a flow chart illustrating a process for adding content in the centralized file management system of FIG. 1; and,

FIG. 6 is a block diagram illustrating a process for adding content in the centralized file management system of FIG. 1.

### DETAILED DESCRIPTION OF THE INVENTION

The present invention is a centralized file management system configured for deployment in a permissions based environment. In accordance with the present invention, a markup language defined user interface can be provided to a communicatively coupled client which permits the selection of multiple files and folders for uploading to a centralized data store. The markup language defined user interface can further permit the assignment of permissions to one or more of the selected files and folders. Other communicatively coupled clients can access the uploaded files and folders based upon the specified file permissions through the markup language defined user interface. Finally, a set of visual notifications can be provided to the clients of the centralized file system to indicate the state of accessible content in the centralized data store.

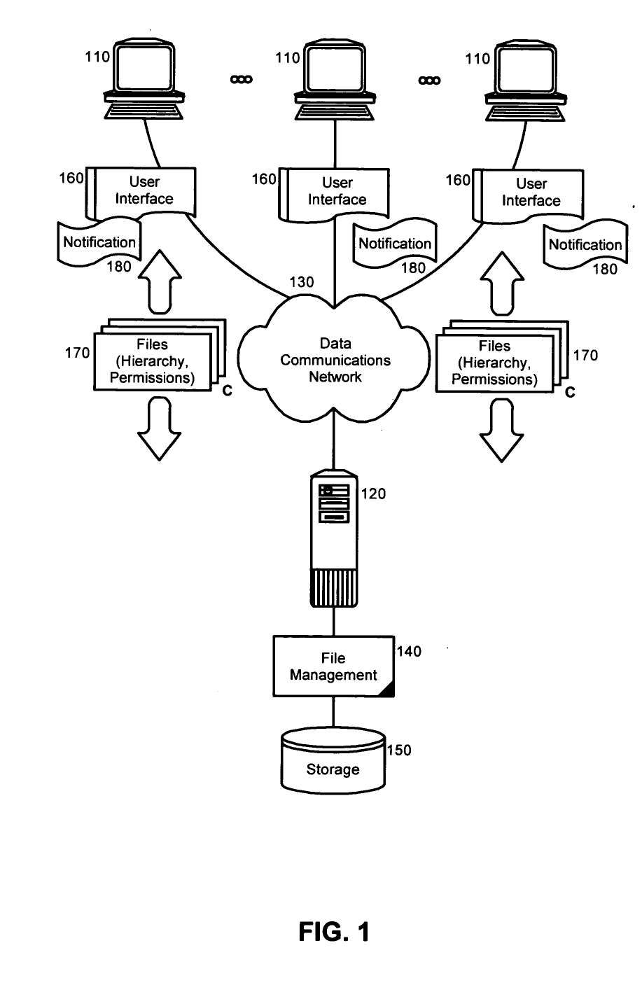

FIG. 1 is a schematic illustration of a centralized file management system configured for deployment in a permissions based environment in accordance with the present invention. The system can include one or more client computing devices communicatively coupled to a server computing device 120 over a data communications network 130, for example the global Internet. The server computing device 120 can include data storage 150 which contents can be managed by a file management process 140 hosted in the server computing device.

Specifically, the file management process 140 can manage each of the uploading, downloading, and permissions of files and file folders to and from the data store 150. To that end, the file management process 140 can generate and distribute a markup language defined user interface 160 for facilitating each of the uploading, downloading, and permissions of files and file folders to and from the data store 150. Advantageously, the user interface 160 can provide a visual control responsive to the selection of which a multitude of files can be selected for addition to the data store 150.

When adding new content to the data store 150, a selection of files can be compressed into a single file 170 for ease of network transfer. Importantly, the local storage hierarchy for the selection of files can be recorded and maintained so that a client computing device 110 downloading the compressed, single file 170 can maintain the storage hierarchy when the files and folders in the compressed, single file 170 are expanded into target storage in the client computing device 110. Moreover, file permissions for the compressed, single file 170 can be recorded and applied when the files and folders in the compressed, single file 170 are expanded into target storage. Finally, for each user registered with the file management process 140, notifications 180 can be provided through the user interface 160 which indicate the state of one or more files or folders disposed within the data store 150 which can be accessed the users.

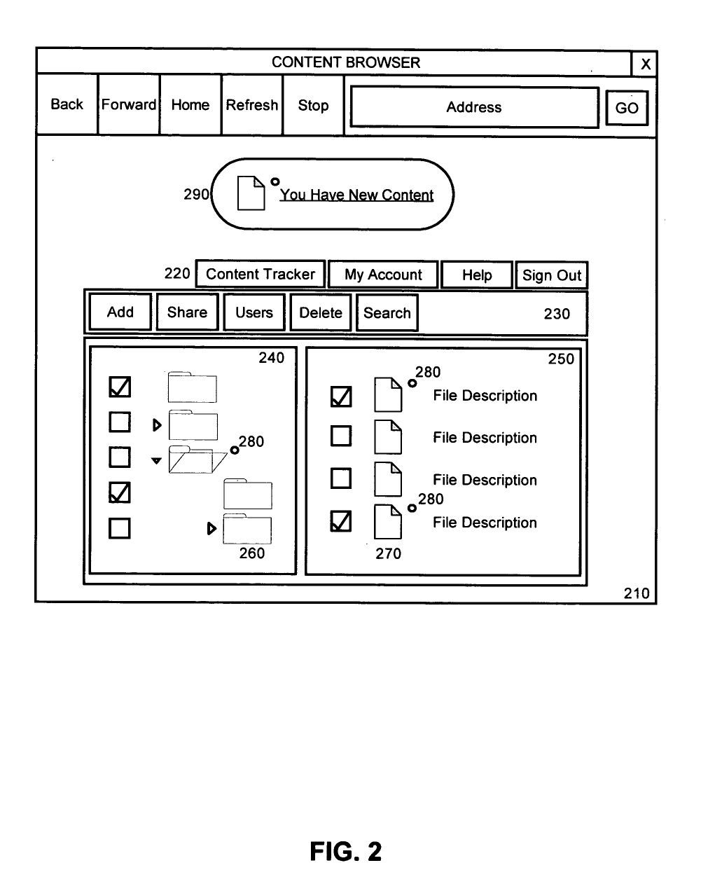

In more particular illustration, FIG. 2 is a screen shot of an exemplary user interface configured for use in the centralized file management system of FIG. 1. In accordance with the present invention, the user interface can be a markup language defined document 210 which can be rendered for viewing in a markup language content browser. The document 210 can include a file navigation display region 240 in which the folders 260 in the file hierarchy of the centralized data store can be presented in a navigable manner to viewers of the rendered markup language document 210. The document 210 also can include a file listing display region 250 in which files 270 organized in a selected one of the folders 260 can be rendered for display.

A tool bar 230 can be provided which can permit the selection of several file manipulation operations. Exemplary file manipulation operations can include operations to add a file or selection of files to the centralized data store, to change file permissions for a file or selection of files in the centralized data store, to manage or view the users registered to access the centralized data store, to delete a file or selection of files in the centralized data store, and to search for a file or selection of files in the centralized data store. A set of navigation tabs 220 also can be provided for permitting access to additional user interface modules for tracking recently accessed content, managing a personal user account, obtaining help, or signing out of the centralized file management system.

Notably, a content alert 290 also can be provided in the rendering of the markup language document 210. The content alert 290 can include notification messages indicating a change of state in one or more of the files in the centralized data store. For instance, when a new file has been added to the centralized data store which can be accessed by a particular user, the rendering of the markup language document 210 for the particular user can include a notification indicating that the particular has “new content”. Similarly, when the permissions for an existing file have been changed in the centralized data store so that the existing file can be accessed by a particular user, the rendering of the markup language document 210 for the particular user can include a notification indicating that the particular has “new content”. Other notifications can include a moved or renamed item, or a new version of an item, to name a few.

When a content alert 290 is provided, a visually distinct content marker 280 similarly can be rendered adjacent to the affected content in the file listing display region 250. Moreover, the content marker 280 can be rendered to a parent folder in the file navigation display region so as to indicate that the affected content resides below the parent folder in the file hierarchy—even if not all of the content in the hierarchy below the parent folder can be accessed by the end user. Importantly, the content marker 280 can have visually distinct features such as color, shape, border style or fill pattern to indicate the nature of the content alert 290. In this regard, while one color can indicate newly added content, a different color can indicate a new version of existing content. In any case, the content marker 280 can remain in a rendered state for a set period of time, or until the affected file has been selected.

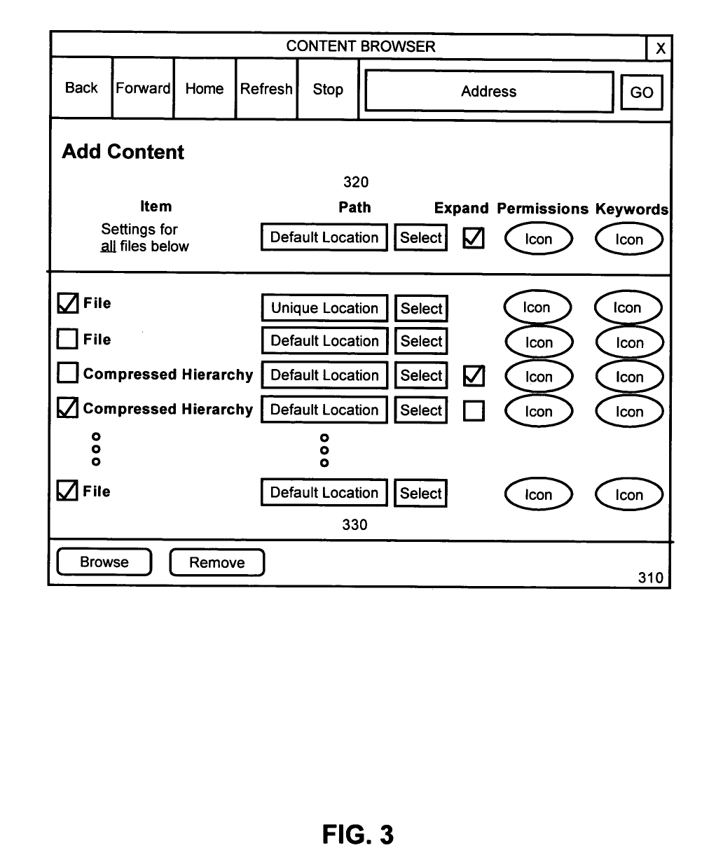

A core function of the centralized file management system can include the addition of new content to the centralized data store. In more particular illustration, FIG. 3 is a screen shot of an exemplary user interface configured for adding content in the centralized file management system of FIG. 1. The exemplary user interface can be a rendered form of a markup language document 310 defining the add content user interface. The document 310 specifically can define a default settings display region 320 and a specific settings display region 330. Moreover, in accordance with the present invention, a single browse button and a single remove button advantageously can be disposed within the user interface defined by the document 310.

While the single remove button can remove selected files from a list of files to be transferred to the centralized data store, the single browse button when activated can launch a file dialog box through which one or more files and folders can be selected for addition to the centralized data store. Specifically, the file dialog box can be used to select individual files for addition to the centralized data store, or to select either or both of multiple files and folders to be combined into a single compressed file. Where a compressed file is to be generated, the structural file hierarchy of the selected files and folders can be recorded so that when the compressed file ultimately is expanded, the selected files and folders can be expanded into the same structural file hierarchy. In all cases, however, no files—compressed or otherwise—are transferred to the centralized data store until the files and folders have been selected through the operation of the browse button.

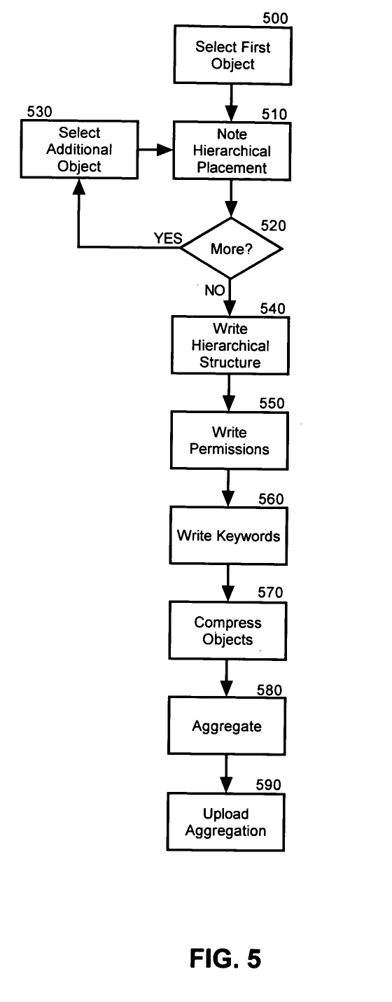

In more specific illustration, FIG. 5 is a flow chart illustrating a process for adding compressed content in the centralized file management system of FIG. 1. Beginning in block 500, a first object can be selected in a local file store for uploading to the centralized file store. In block 510 the hierarchical placement of the object can be noted. In decision block 520, if more files are to be selected, in block 530 an additional object can be selected and again, in block 510, the hierarchical placement of the object can be noted. This process can continue until no more objects remain to be selected for compression. Subsequently, the noted hierarchical placements can be organized into a hierarchical structure and associated with the selected objects.

In block 550 the permissions for the selected objects can be written and any keywords for the selected objects further can be written in block 560. In block 570, the selected objects can be compressed into a compressed object and in block 580 the compressed object, the permissions and the keywords can be aggregated into a single file. Finally, in block 590 the aggregation can be uploaded to the centralized data store. Significantly, unlike conventional Web driven document management systems, none of the individually selected objects in the aggregation in the centralized file management system of the present invention can be uploaded until all have been selected, compressed and aggregated with the keyword and hierarchy information.

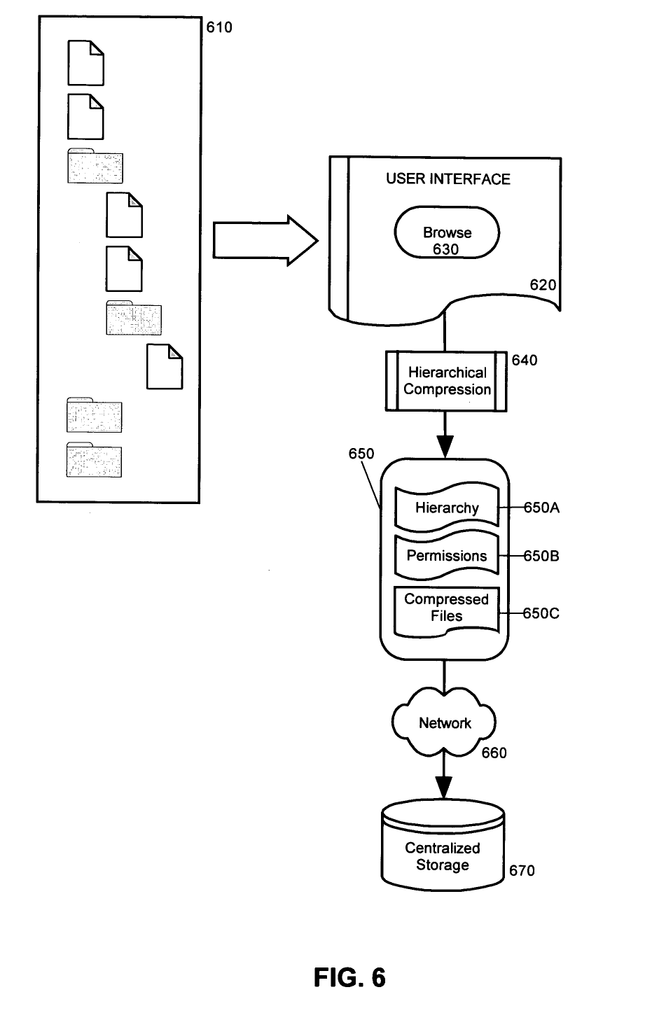

In this regard, FIG. 6 is a block diagram illustrating a process for adding content in the centralized file management system of FIG. 1. As it will be apparent to the skilled artisan, an entire hierarchy 610 of files and folders can be identified through a single selection of a browse button 630 in the add content user interface 620. Based upon the selection, the hierarchy can be reduced to a hierarchical compression 640 and combined in an aggregation 650 of hierarchical data 650A, permissions 650B and compressed files and folders 650C. Subsequently, the aggregation 650 can be forwarded over the network 660 to the centralized data store 670. In this way, the advantages of a single file transfer over the narrow bandwidth of the network can be achieved without requiring the end user to sequentially select and upload individual files while losing entirely the hierarchical information associated with the sequentially uploaded files.

Returning now to FIG. 3, once the files—whether compressed or otherwise—have been earmarked for transfer to the centralized data store, both default settings and specific setting can be applied to the files. In the default settings display region 320, settings can be applied generically to the listed files. The settings can include a default location for writing the files to a client computing device, whether or not a compressed file is to be automatically expanded when downloaded to a client computing device, selected file permissions, and keywords to be associated with the file for use in a searching operation. By comparison, in the specific settings display region 330, settings can be applied specifically to corresponding ones of the listed files.

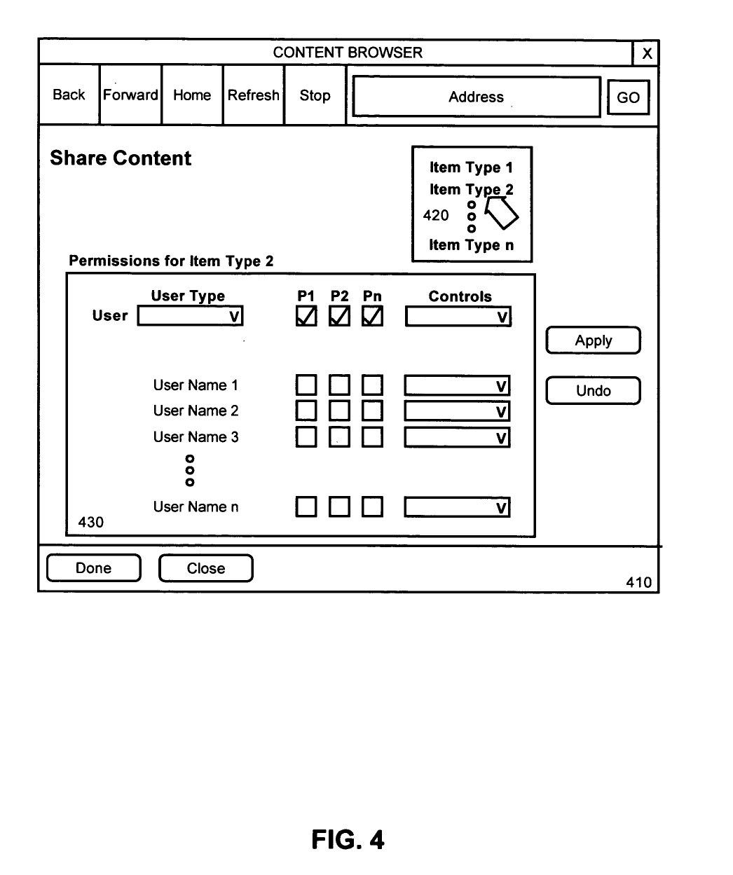

Once files have been uploaded to the centralized data store, the permissions for the uploaded files can be managed through a user interface defined by a distributable markup language document. In particular, FIG. 4 is a screen shot of an exemplary user interface for assigning permissions for shared content in the centralized file management system of FIG. 1. The exemplary user interface can be defined by a markup language document 410 and can include an item display region 420 and a permission settings display region 430. The item display region 420 can include a listing of items or item types. In this regard, items can include uploaded files, whether compressed or otherwise, folders and classifications or types of items. Based upon a selection of an item or item type in the item display region 420, a set of permissions can be established for the selection in the permissions settings display region 430.

Within the permissions settings display region 430, a user type can be specified for permissions assignment with respect to the selected item. Permissions can include but are not limited to view (read-only), write (view, edit or add) and control (view, edit, add, delete, rename, change permissions). The user type can be a classification associated with one or more users, such as administrator or guest. A set of general, default permissions can be assigned to the user type. Additionally, a listing of all users assigned to the user type can be listed and the permissions can be specifically overridden for one or more of the users in the user type. To further automate the permissions assignment process, a control can be selected which can specify whether the specified permissions for the user or user type are to propagate to the children of the item, whether the default permissions for the user are to propagate to the children of the item, whether the permissions from of the parent of the selected item are to be inherited, or whether to clear all assigned permissions to the selected item, to name a few.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

What is claimed is:

1. A network file transfer method comprising the steps of:
responsive to the activation of a browse control in a file transfer user interface, displaying a file hierarchy for locally accessible files;
selecting at least one file from said hierarchy;
repeating said displaying and selecting steps for additional activations of said browse control; and,
subsequent to said repeating step, uploading each of said selected files to a centralized data store over a computer communications network.

2. The method of claim 1, further comprising the step of rendering said browse control based upon a markup language definition for said browse control.

3. The method of claim 1, further comprising the steps of:
compressing at least two of said selected files into a compressed file;
recording a file hierarchy for said at least two selected files;
aggregating said file hierarchy and said compressed file; and,
uploading said aggregation to said centralized data store along with said selected files.

4. The method of claim 1, further comprising the step of designating different target paths for different ones said selected files.

5. The method of claim 1, further comprising the step of designating different permissions for different ones of said selected files.

6. The method of claim 1, further comprising the step of designating different search keywords for different ones of said selected files.

7. The method of claim 3, further comprising the step of specifying whether said compressed file is to be automatically expanded when downloaded from said centralized data store.

8. The method of claim 1, further comprising the step of rendering a user specific content alert in said file transfer user interface responsive to detecting a state change in said centralized data store.

9. The method of claim 1, further comprising the steps of:
associating said content alert with a content marker; and,
rendering said content market adjacent to a file associated with said state change.

10. A distributable file transfer user interface article of manufacture comprising:
a file navigation display region;
a file listing display region; and,
a content alert configured to alert viewers to state changes to content which can be accessed through said display regions.

11. The article of manufacture of claim 10, further comprising at least one content marker associated with said content alert and positioned adjacent to content associated with a state change.

12. A machine readable storage having stored thereon a computer program for network file transfers, the computer program comprising a routine set of instructions which when executed by a machine causes the machine to perform the steps of:
responsive to the activation of a browse control in a file transfer user interface, displaying a file hierarchy for locally accessible files;
selecting at least one file from said hierarchy;
repeating said displaying and selecting steps for additional activations of said browse control; and,
subsequent to said repeating step, uploading each of said selected files to a centralized data store over a computer communications network.

13. The machine readable storage of claim 12, further comprising an additional set of instructions for causing the machine to perform the additional step of rendering said browse control based upon a markup language definition for said browse control.

14. The machine readable storage of claim 12, further comprising an additional set of instructions for causing the machine to perform the additional steps of:
compressing at least two of said selected files into a compressed file;
recording a file hierarchy for said at least two selected files;
aggregating said file hierarchy and said compressed file; and,
uploading said aggregation to said centralized data store along with said selected files.

15. The machine readable storage of claim 12, further comprising an additional set of instructions for causing the machine to perform the additional step of designating different target paths for different ones said selected files.

16. The machine readable storage of claim 12, further comprising an additional set of instructions for causing the machine to perform the additional step of designating different permissions for different ones of said selected files.

17. The machine readable storage of claim 12, further comprising an additional set of instructions for causing the machine to perform the additional step of designating different search keywords for different ones of said selected files.

18. The machine readable storage of claim 14, further comprising an additional set of instructions for causing the machine to perform the additional step of specifying whether said compressed file is to be automatically expanded when downloaded from said centralized data store.

19. The machine readable storage of claim 12, further comprising an additional set of instructions for causing the machine to perform the additional step of rendering a user specific content alert in said file transfer user interface responsive to detecting a state change in said centralized data store.

20. The machine readable storage of claim 12, further comprising an additional set of instructions for causing the machine to perform the additional steps of:
associating said content alert with a content marker; and,
rendering said content market adjacent to a file associated with said state change.
